(19) United States
(12) Patent Application Publication
(10) Pub. No.: US 2018/0330250 A1
(43) Pub. Date: Nov. 15, 2018

(54) ENERGY MANAGEMENT SYSTEM WITH INTELLIGENT ANOMALY DETECTION AND PREDICTION

(71) Applicant: NEC Laboratories America, Inc., Princeton, NJ (US)

(72) Inventors: Kiyoshi Nakayama, Santa Clara, CA (US); Ratnesh Sharma, Fremont, CA (US)

(73) Assignee: NEC Laboratories America, Inc., Princeton, NJ (US)

(21) Appl. No.: 15/974,155

(22) Filed: May 8, 2018

Related U.S. Application Data
(60) Provisional application No. 62/503,390, filed on May 9, 2017.

(51) Int. Cl. G06N 5/04; G06N 99/00; H02J 13/00

(52) U.S. Cl. CPC G06N 5/04; H02J 13/0006; G06N 99/005

(57) ABSTRACT

A computer-implemented method for detecting and predicting anomalies in an energy management system is presented. The method includes detecting, in real-time, a first set of outliers for a plurality of energy devices under operation, predicting a second set of outliers for running the plurality of energy devices, analyzing historical energy data of the plurality of energy devices to extract a third set of outliers, receiving feedback, in real-time, from a user regarding each of the first, second, and third sets of outliers, and training the energy management system with the real-time feedback received from the user to automatically optimize a threshold of error detection.

### RELATED APPLICATION INFORMATION

This application claims priority to Provisional Application No. 62/503,390, filed on May 9, 2017, incorporated herein by reference in its entirety.

### BACKGROUND

### Technical Field

The present invention relates to energy management systems and, more particularly, to energy management systems with intelligent anomaly detection and prediction.

### Description of the Related Art

Energy management systems (EMS) are developed to optimize usage of energy systems and/or grid operations. In particular, energy storages are being deployed in commercial and industrial (C&I) customer buildings, with Behind-The-Meter (BTM) energy applications, as well as in residential premises. Microgrids are also being developed and deployed in many areas around the world. One of the research areas, for instance, pertains to optimizing batteries and minimizing costs that customers incur from peak prices such as Demand Charge (DC).

### SUMMARY

A computer-implemented method for detecting and predicting anomalies in an energy management system is presented. The method includes detecting, in real-time, a first set of outliers for a plurality of energy devices under operation, predicting a second set of outliers for running the plurality of energy devices, analyzing historical energy data of the plurality of energy devices to extract a third set of outliers, receiving feedback, in real-time, from a user regarding each of the first, second, and third sets of outliers, and training the energy management system with the real-time feedback received from the user to automatically optimize a threshold of error detection.

A system for detecting and predicting anomalies in an energy management system is also presented. The system includes a memory and a processor in communication with the memory, wherein the processor is configured to detect, in real-time, a first set of outliers for a plurality of energy devices under operation, predict a second set of outliers for running the plurality of energy devices, analyze historical energy data of the plurality of energy devices to extract a third set of outliers, receive feedback, in real-time, from a user regarding each of the first, second, and third sets of outliers, and train the energy management system with the real-time feedback received from the user to automatically optimize a threshold of error detection.

A non-transitory computer-readable storage medium comprising a computer-readable program is presented for detecting and predicting anomalies in an energy management system, wherein the computer-readable program when executed on a computer causes the computer to perform the steps of detecting, in real-time, a first set of outliers for a plurality of energy devices under operation, predicting a second set of outliers for running the plurality of energy devices, analyzing historical energy data of the plurality of energy devices to extract a third set of outliers, receiving feedback, in real-time, from a user regarding each of the first, second, and third sets of outliers, and training the energy management system with the real-time feedback received from the user to automatically optimize a threshold of error detection.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating an overall procedure of integrating future, current, and past anomaly detections, in accordance with embodiments of the present invention;

FIG. 2 is a block/flow diagram illustrating a procedure of real-time outlier detection for energy devices under operation, in accordance with embodiments of the present invention;

FIG. 3 is a block/flow diagram illustrating feedback analysis of human inputs in real-time anomaly detection, in accordance with embodiments of the present invention;

FIG. 4 is a block/flow diagram illustrating a procedure of outlier prediction for running energy devices, in accordance with embodiments of the present invention;

FIG. 5 is a block/flow diagram illustrating feedback analysis of human inputs in future anomaly detection, in accordance with embodiments of the present invention;

FIG. 6 is a block/flow diagram illustrating a procedure of historical energy data anomaly analysis and optimization, in accordance with embodiments of the present invention;

FIG. 7 is a block/flow diagram illustrating feedback analysis of human inputs in past anomaly detection, in accordance with embodiments of the present invention;

FIG. 8 is a block/flow diagram illustrating optimization of usage of energy systems, in accordance with embodiments of the present invention;

FIG. 9 is a block/flow diagram illustrating execution of an energy management system with intelligent anomaly detection and prediction, in accordance with embodiments of the present invention;

FIG. 10 is an exemplary processing system for detecting and predicting anomalies in an energy management system, in accordance with embodiments of the present invention; and

FIG. 11 is an exemplary resilient distributed architecture of an energy management system, in accordance with embodiments of the present invention.

### DETAILED DESCRIPTION OF PREFERRED EMBODIMENTS

In the exemplary embodiments of the present invention, methods and devices are presented for employing an autonomous energy management platform that enables dynamic configuration and operation, fault detection, and system recovery. An exemplary energy management system (EMS) can include, e.g., an operational platform, a management engine, resilience controller(s), and an EMS database, all of which are connected through Internet communications protocols. The operational platform can make the EMS operations more resilient where the autonomous mechanisms are enabled with system upgrade, maintenance, enhancement, and failure recovery. The management engine can aggregate distributed energy resources (DERs) to conduct economic optimization and dispatches management commands to the energy resources. The management engine receives input of historical data on load and renewable profiles, and conducts forecasting to generate optimum battery and grid-power profiles based on at least electricity price, battery degradation, and demand charge rates. The resilience controller aggregates the devices that require controls. Intelligent anomaly detection functions are further implemented in the operational platform and the resilience controller, such that analyzed data can be employed by the management engine.

In the exemplary embodiments of the present invention, a method for detecting unexpected events or accidents relevant to energy systems or a grid when there is some abnormal condition in those systems is presented. Therefore, detecting anomaly in past data, current real-time data, and future predicted data, and recovering the outlier based on the detection are useful and advantageous detectable aspects in the operation of energy systems. Realizing resilient energy management systems by detecting and dealing with anomaly and/or outliers in real-time is important before it leads to a serious business loss caused by sudden outlier of energy operations. Detecting and revising the potential outliers in the past data profiles stored in the EMS should also be performed before optimizing and controlling energy systems to avoid system failures and/or extra charges caused by exploiting anomaly data. In addition, predicting system faults to replace and restore energy system(s) needs to be addressed to minimize the risk of interrupting operation of energy systems.

In the exemplary embodiments of the present invention, a method and system is presented for implementing an EMS with intelligent anomaly detection and prediction that integrates intelligent anomaly detection schemes and solves real-time anomaly detection and prediction, as well as anomaly extraction and correction from past data to be employed in optimizations using the EMS. The present invention further employs predicting techniques and integrating operators' feedback to improve an error filtering scheme in the backend of the EMS. Additionally, the exemplary embodiments of the present invention provide for classifying data into faults such as thresholds and employing the feedback from an expert, such as a system operator, who can contribute to improving filtering anomaly (sophisticated feedback analysis of human inputs).

In the exemplary embodiments of the present invention, a method and system is presented for implementing an operator's knowledge to sophisticate anomaly filtering process by employing: A) real-time outlier detection from energy devices under operation, B) outlier prediction for running energy devices, and C) historical energy data anomaly analysis and optimization.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

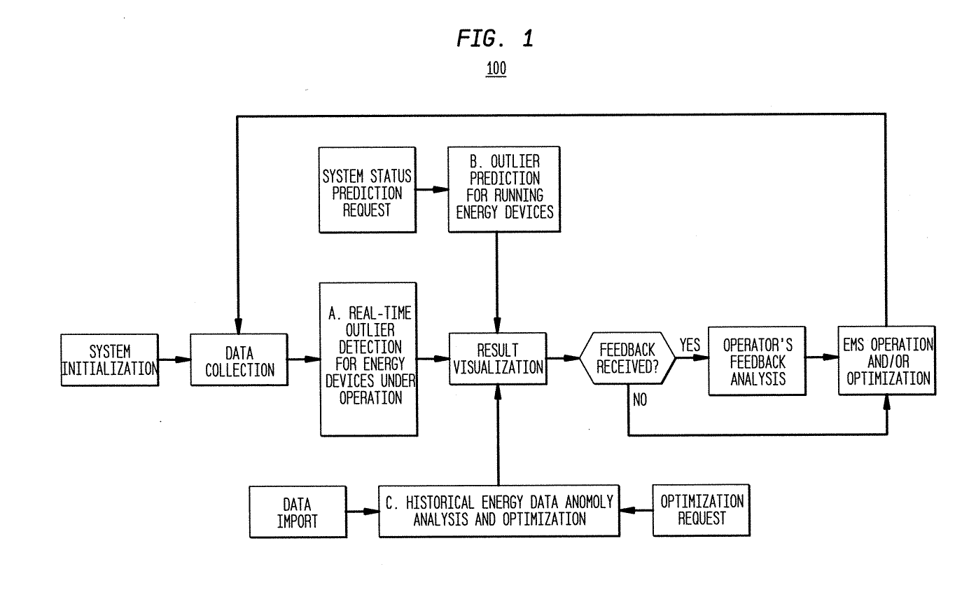

FIG. 1 is a block/flow diagram 100 illustrating an overall procedure of integrating future, current, and past anomaly detections, in accordance with embodiments of the present invention.

The EMS integrates the following functions and is designed to incorporate an operator's knowledge to sophisticate anomaly filtering processes. The main components of the EMS are: (1) real-time outlier detection from energy devices under operation, (2) outlier prediction for running energy devices, and (3) historical energy data anomaly analysis and optimization. The results made by those functions are visualized through visual aid tools (e.g., displays) so that an operator or user can provide feedback, continuously and in real-time, on the results.

Regarding the real-time outlier detection for energy devices under operation, detection of any outliers and faults in real-time is a primary and necessary function in operation of microgrids and BTM applications. Several theoretical frameworks have been proposed to apply data-driven models to energy management systems. However, the real-time outlier detection module of the present invention realizes the automation of the framework and optimization of anomaly filtering based on human interactions.

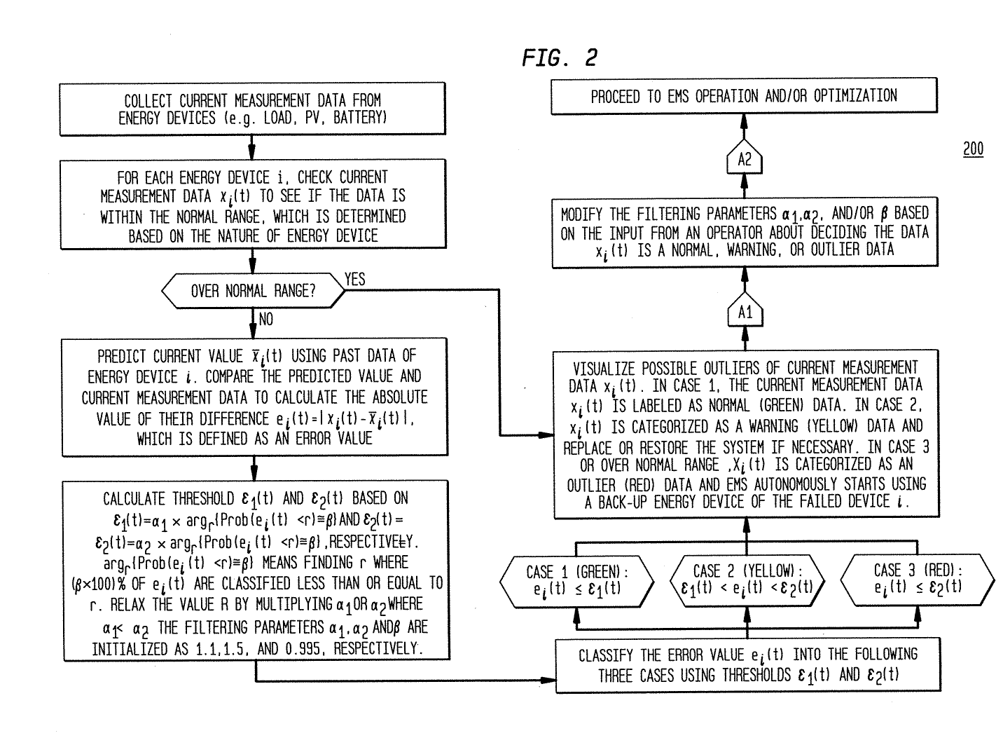

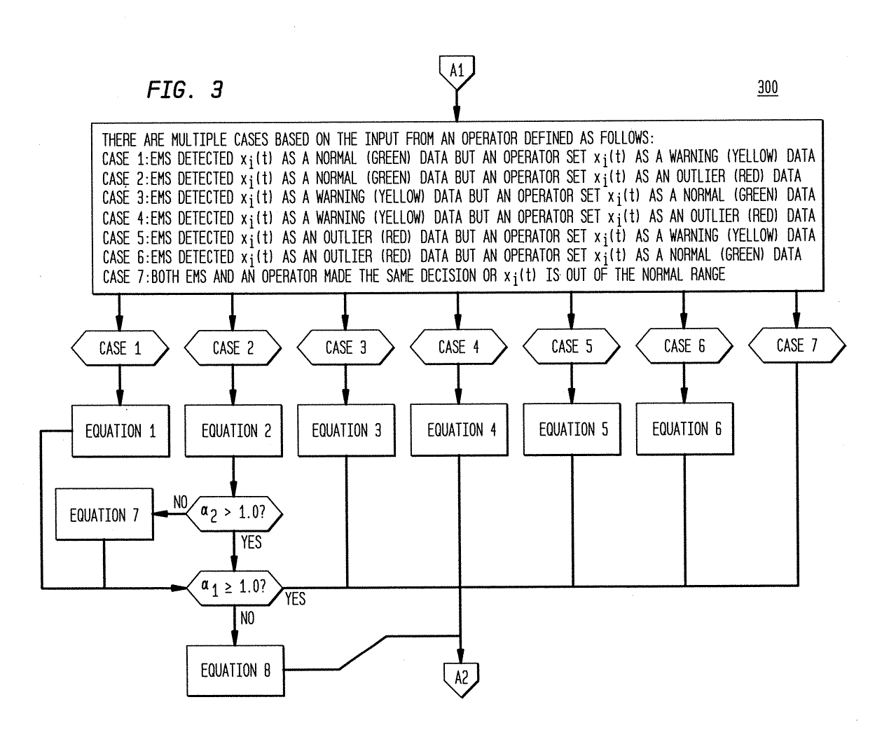

FIG. 2 is a block/flow diagram 200 illustrating a procedure of real-time outlier detection for energy devices under operation, in accordance with embodiments of the present invention, whereas FIG. 3 is a block/flow diagram 300 illustrating feedback analysis of human inputs in real-time anomaly detection, in accordance with embodiments of the present invention.

Block/flow diagrams 200 and 300 illustrate how to realize real-time detection of a potential outlier. Any advanced techniques of predicting a next step energy data can be employed, such as extracting relationships among time-series data sets based on the theoretical framework of model-based (e.g., recursive Bayesian filtering) and data-driven (e.g., auto-regression with exogenous inputs and exploratory factor analysis) approaches. The current measurement data is then categorized into, e.g., one of three cases: normal data, warning data, and outlier data. An operator or user can provide feedback to the detection result and the feedback can be analyzed to make the outlier filtering better in the next operation or iteration. There are, e.g., seven cases in analyzing the gap between the system result and operators input, and depending on the gap the filtering parameter(s), they are automatically updated behind the backend module in the EMS.

In particular, the procedure of Algorithm 1, reproduced below, is an algorithm which helps decide the filtering parameters. There are error filtering thresholds {e₁(t), e₂(t)} to filter the error values. The calculation of {e₁(t), e₂(t)} is based on eᵢ(t)=αᵢ×argᵣ{Prob(eᵢ(t))<r)≅β, where i=1,2. The meaning of those thresholds is that the possibility of xᵢ(t) being an outlier or fault is low if eᵢ(t)<e₁(t), relatively high if e1(t)<ei(t)<e2(t), and quite high if eᵢ(t)>e₂(t). The values α₁, α₂ and β are initialized at first as 1.1, 1.5, and 0.995, respectively, and are trained based on the operator's or user's input.

From the operator side, the operator or user has an option to adjust a level of anomaly possibility. If the operator decides that the data is broken even if it is not classified to be an outlier by EMS, the operator can re-label or re-designate the data as outlier data. Therefore, the EMS and the operator can make the same decision over the possibility of the current measurement data being an outlier, or the EMS and the operator can differ in deciding on anomaly possibility.

If the decision between the EMS and the operator is different, there are in total 7 cases to describe the gap in decision as follows:

Case 1: EMS detected xᵢ(t) as a normal (green) data X but an operator set xᵢ(t) as a warning (yellow) data Y.

Case 2: EMS detected xᵢ(t) as a normal (green) data X but an operator set xᵢ(t) as an outlier (red) data Z.

Case 3: EMS detected xᵢ(t) as a warning (yellow) data Y but an operator set xᵢ(t) as a normal (green) data X.

Case 4: EMS detected xᵢ(t) as a warning (yellow) data Y but an operator set xᵢ(t) as an outlier (red) data Z.

Case 5: EMS detected xᵢ(t) as an outlier (red) data Z but an operator set xᵢ(t) as a warning (yellow) data Y.

Case 6: EMS detected xᵢ(t) as an outlier (red) data Z but an operator set xᵢ(t) as a normal (green) data X.

Case 7: Both EMS and an operator made the same decision or xᵢ(t) is out of the normal range.

Depending on which case the gap of the decision is categorized, the parameters of α₁, α₂ and β are accordingly calculated with the rules shown in Algorithm 1.

For instance, if the gap is categorized as Case 3, α₁ is updated to α₁←eᵢ(t)/argᵣ{Prob(eᵢ(t)<r)≅β}, while α₂ and β remains the same.

In FIG. 3:

$$\begin{matrix}{α}_{1} ← \frac{{e}_{i} ( t ) - ϵ}{{arg}_{r} \{ Prob ( {e}_{i} ( t ) < r ) ≅ β \}} & Equation 1 \\ {α}_{1} ← \frac{{e}_{i} ( t ) \times 0.05}{{arg}_{r} {\{ Prob ( {e}_{i} ( t ) < r ) ≅ β \}}^{′}} \\ {α}_{2} ← \frac{{e}_{i} ( t )}{{arg}_{r} \{ Prob ( {e}_{i} ( t ) < r ) ≅ β \}} & Equation 2 \\ {α}_{1} ← \frac{{e}_{i} ( t )}{{arg}_{r} \{ Prob ( {e}_{i} ( t ) < r ) ≅ β \}} & Equation 3 \\ {α}_{2} ← \frac{{e}_{i} ( t ) + ϵ}{{arg}_{r} \{ Prob ( {e}_{i} ( t ) < r ) ≅ β \}} & Equation 4 \\ {α}_{2} ← \frac{{e}_{i} ( t ) + ϵ}{{arg}_{r} \{ Prob ( {e}_{i} ( t ) < r ) ≅ β \}} & Equation 5 \\ {α}_{1} ← \frac{{e}_{i} ( t )}{{arg}_{r} {\{ Prob ( {e}_{i} ( t ) < r ) ≅ β \}}^{′}} \\ {α}_{2} ← \frac{{e}_{i} ( t ) \times 1.5}{{arg}_{r} \{ Prob ( {e}_{i} ( t ) < r ) ≅ β \}} & Equation 6 \\ {r}^{′} = \begin{matrix}{α}_{1} ← 1.0 , r = {e}_{i} ( t ) - θ , \\ {e}_{i} ( t ) , β ← Prob ( {e}_{i} ( t ) < r ) , \\ {α}_{2} ← \frac{{e}_{i} ( t )}{{arg}_{r} \{ Prob ( {e}_{i} ( t ) < {r}^{′} ) ≅ β \}}\end{matrix} & Equation 7 \\ {α}_{1} ← 1.0 , r = {e}_{i} ( t ) , \\ β = Prob ( {e}_{i} ( t ) < r ) . & Equation 8\end{matrix}$$

The algorithm is:

Algorithm 1
Optimizing filering parameters based on human
inputs in real-time anomaly detection.

| | |
|---|---|
| 1: | if labelₛ(xᵢ(t)) = [symbol] ∩ labelₒ(xᵢ(y)) = [symbol] then |
| 2: | ${α}_{1} ← \frac{{e}_{i} ( t ) - ɛ}{{arg}_{r} \{ Prob ( {e}_{i} ( t ) < r ) ≃ β \}} .$ |
| 3: | if α₁ < 1.0 then |
| 4: | α₁ ← 1.0, r ← e₁(t), β ← Probe(eᵢ(t) < r). |
| 5: | end if |
| 6: | else if labelₛ(xᵢ(t)) = [symbol] ∩ labelₒ(xᵢ(t)) = [symbol] then |
| 7: | ${α}_{1} ← \frac{{e}_{i} ( t ) \times 0.8}{{arg}_{r} \{ Prob ( {e}_{i} ( t ) < r ) ≃ β \}} .$ |
| 8: | ${α}_{2} ← \frac{{e}_{i} ( t )}{{arg}_{r} \{ Prob ( {e}_{i} ( t ) < r ) ≃ β \}} .$ |
| 9: | if α₂ ≤ 1.0 then |
| 10: | α₁ ← 1.0, r ← e₁(t) − θ, r′ = eᵢ(t), β ← Probe(eᵢ(t) < r). |
| 11: | ${α}_{2} ← \frac{{e}_{i} ( t )}{{arg}_{r} \{ Prob ( {e}_{i} ( t ) < r ) ≃ β \}} .$ |
| 12: | end if |
| 13: | if α₁ < 1.0 then |
| 14: | α₁ ← 1.0, r ← eᵢ(t), β ← Prob(eᵢ(t) < r). |
| 15: | end if |
| 16: | else if labelₛ(xᵢ(t)) = [symbol] ∩ labelₒ(xᵢ(y)) = [symbol] then |
| 17: | ${α}_{1} ← \frac{{e}_{i} ( t )}{{arg}_{r} \{ Prob ( {e}_{i} ( t ) < r ) ≃ β \}} .$ |
| 18: | else if labelₛ (xᵢ(t)) = [symbol] ∩ labelₒ(xᵢ(y)) = [symbol] then |
| 19: | ${α}_{2} ← \frac{{e}_{i} ( t )}{{arg}_{r} \{ Prob ( {e}_{i} ( t ) < r ) ≃ β \}} .$ |
| 20: | else if labelₛ (xᵢ(t)) = [symbol] ∩ labelₒ(xᵢ(y)) = [symbol] then |
| 21: | ${α}_{2} ← \frac{{e}_{i} ( t ) + ɛ}{{arg}_{r} \{ Prob ( {e}_{i} ( t ) < r ) ≃ β \}} .$ |
| 22: | else if labelₛ (xᵢ(t)) = [symbol] ∩ labelₒ(xᵢ(y)) = [symbol] then |
| 23: | ${α}_{1} ← \frac{{e}_{i} ( t )}{{arg}_{r} \{ Prob ( {e}_{i} ( t ) < r ) ≃ β \}} .$ |
| 24: | ${α}_{2} ← \frac{{e}_{i} ( t ) \times 1.2}{{arg}_{r} \{ Prob ( {e}_{i} ( t ) < r ) ≃ β \}} .$ |
| 25: | else |
| 26: | α₁, α₂, and β stay the same |
| 27: | end if |

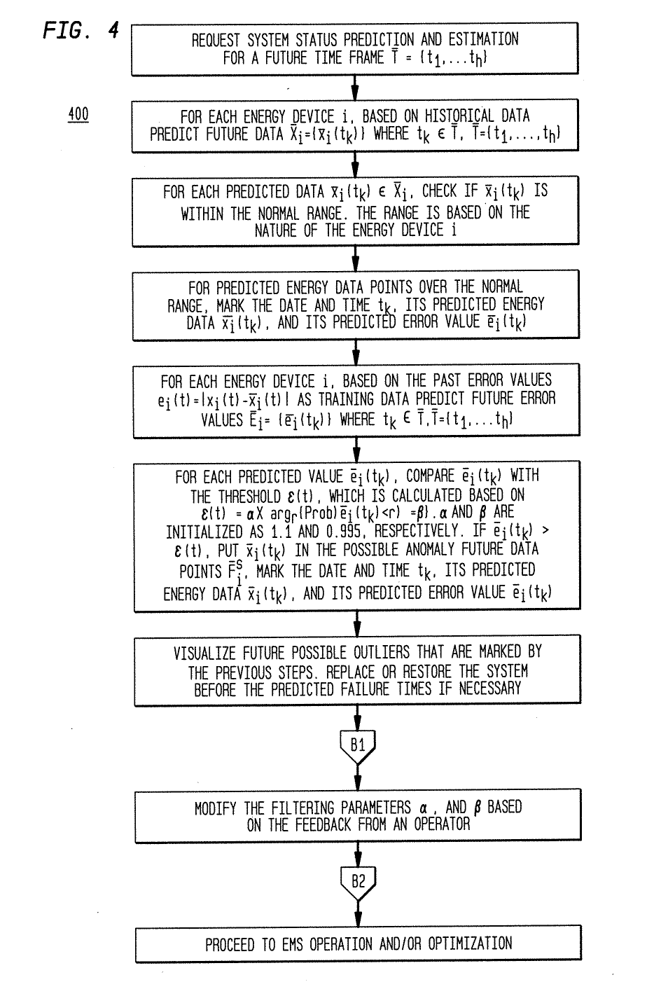

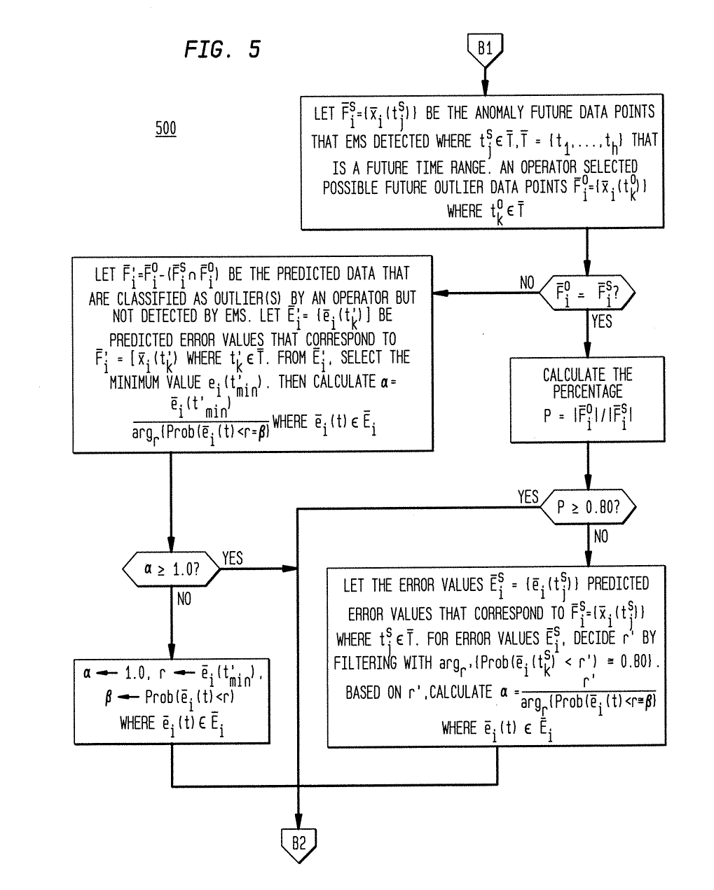

FIG. 4 is a block/flow diagram 400 illustrating a procedure of outlier prediction for running energy devices, in accordance with embodiments of the present invention, whereas FIG. 5 is a block/flow diagram 500 illustrating feedback analysis of human inputs in future anomaly detection, in accordance with embodiments of the present invention.

Regarding the outlier prediction engine for running energy devices, there are, e.g., two ways to realize outlier prediction. One is to forecast the data profiles related to energy based on the advanced forecasting scheme and check whether the predicted values are within normal range based on the nature of energy systems. If the data goes beyond the threshold(s), it provides the operator with a warning.

Regarding future energy data analysis:

A first check point is that the predicted energy data from now to some point in the future (e.g., day-ahead, week-ahead, month-ahead, etc.) goes beyond the normal range that are decided based on the power system properties. If there are time(s) that go beyond defined threshold(s), this procedure extracts its timestamp and lets an operator know about when the failure(s) is/are going to occur.

Regarding future error values analysis:

Another check point is on the analysis of predicted error values. The error value is the difference between the predicted value and the real measurement data. The future error values can be predicted based on the past error values stored in EMS. This procedure forecasts the error trend by analyzing if the error data is within the range of a certain error threshold. If it is out of the range, EMS extracts its timestamp(s) to notify when the outlier(s) will occur.

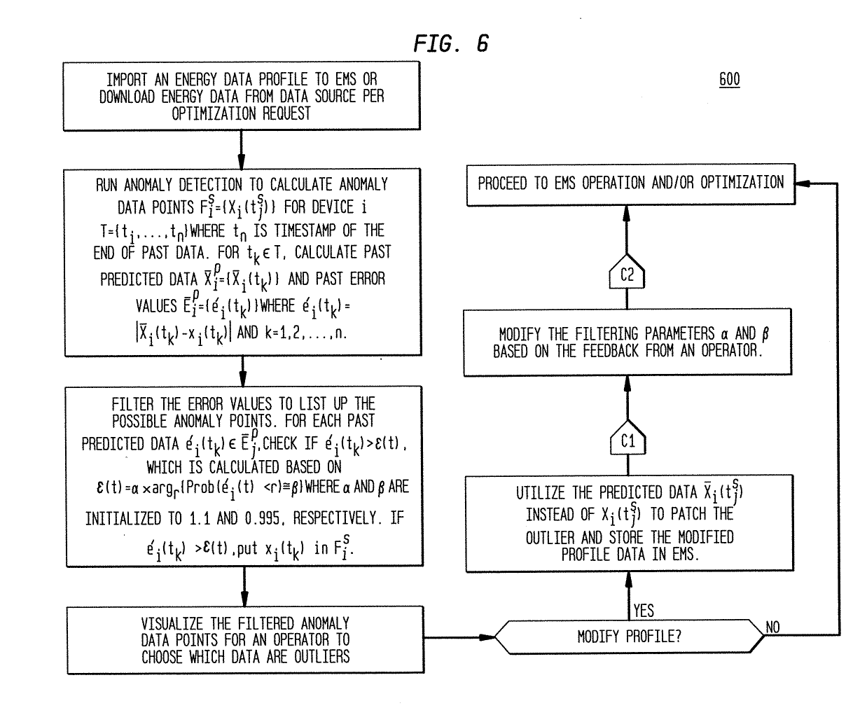

The flowchart in FIG. 4 depicts how the EMS extracts the potential outliers. A difference from other techniques is that the EMS can employ past error values of the measurement energy data to predict future error values, where ēᵢ(tₖ^{s), t}ₖ^{s}∈T̅ is a future time range. All the predicted error values are compared with the threshold e(tₙ), where tₙ is the current time. If the error goes beyond the threshold, the possible failures in the future are visualized to an operator. The operator can also decide which detections are outliers or not, and eventually α and β can be trained as shown in FIG. 6.

FIG. 6 is a block/flow diagram 600 illustrating a procedure of historical energy data anomaly analysis and optimization, in accordance with embodiments of the present invention.

All the error filtering is based on threshold comparison such as eᵢ(t)>eᵢ(t) where eᵢ(t)=αᵢ×argᵣ{Prob(eᵢ(t))<r)=β} with the percentage of whole data β and relaxing factor α. The parameters α and β are usually initialized as 1.1 and 0.995, respectively, which are trained based on human inputs. Error filtering of energy systems varies depending on the nature of the system or human behavior.

Therefore, it is inevitable to train filtering parameters using expertise from an operator or technicians with power system domain knowledge. For example, if both an operator and the EMS decide the measurement value xᵢ(t) is outlier or failed data, the values of α and β remain the same. Otherwise, α and β are updated based on the corresponding error value eᵢ(t). While other techniques try to refine the theoretical modeling and performance, incorporating human knowledge, expertise, and even intuition into the outlier filtering process improves the detection of outlier data.

Regarding the historical energy data anomaly analysis and optimization, use of the damaged profiles to optimize the grid or energy systems causes the miscalculation of control points such as charging and discharging profiles for batteries. For instance, because of miscalculation of the profiles, EMS will not be able to capture the load peak and misses a chance to curtail peak load when it is necessary. That causes incurring higher cost by receiving extra power from the grid, which increases the cost of demand charge (DC) for BTM customers. The module for handling historical energy data realizes its anomaly detection and data optimization, which improves the performance of the EMS operations, optimizations, and management. The prediction scheme can be any advanced techniques such as autoregressive (AR) and/or autoregressive with exogenous input (ARX) and its prediction can be employed to patch failed data within the past energy data.

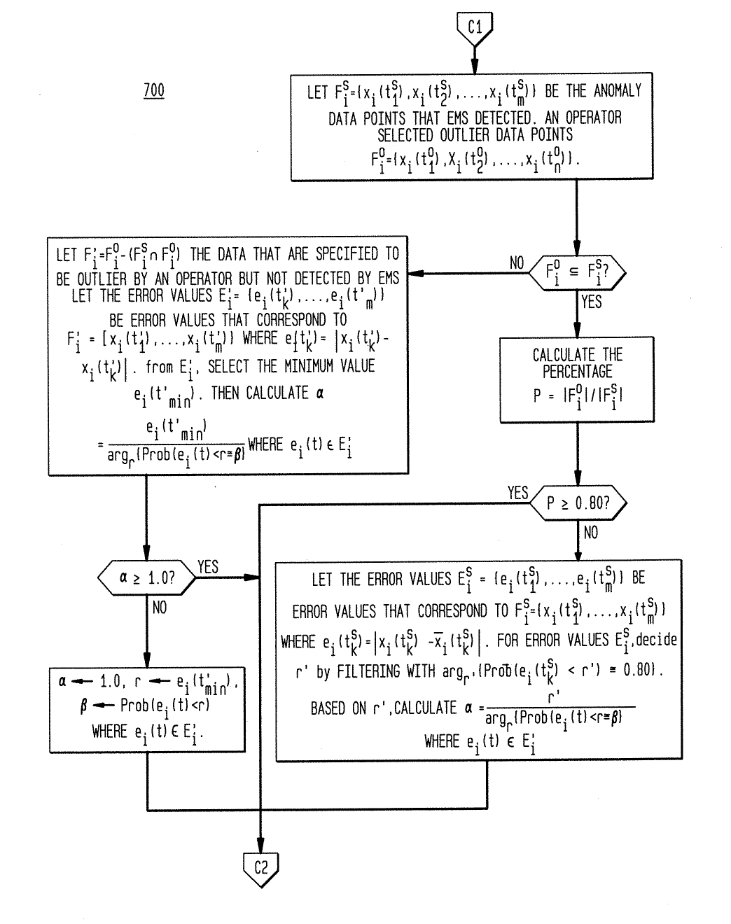

FIG. 7 is a block/flow diagram 700 illustrating feedback analysis of human inputs in past anomaly detection, in accordance with embodiments of the present invention.

When importing energy data to the systems or analyzing the historical data for the purpose of data cleaning or optimization, the system needs to properly extract the associated information attached to the raw data. FIG. 7 relates to feedback analysis of human inputs in past anomaly detection that is new and different from other schemes. Fᵢ^{o} and Fᵢ^{o} are the list of possible failures selected by EMS and an operator, respectively. The check point is that the possible outliers can be precisely captured by the system or not, which can be filtered by Fᵢ^{o}∈Fᵢ^{s}. If all of them are captured by the system, the EMS checks whether the number of the possible outliers is too large or not by looking at the capturing rate P. If the rate is less than 80%, “a” is recalculated so that EMS can narrow down the possible outliers.

Regarding FIGS. 1-7, this invention has integrated all three EMS modules to extract outliers from past, current, and future data profiles, and automate all the detection procedures. Effectively integrating the three core modules of anomaly detection is inevitable to conduct resilient operation of EMS, as well as preventing a business loss from unexpected operation of the energy systems.

Among individual detection functions, the exemplary procedure is an efficient human feedback analysis procedure derived from operator feedback, which improves the detection performance of actual outliers by presenting possible anomaly data to an operator who possesses enough knowledge and expertise to decide on outliers. In most cases, the feedback from an expert, such as a system operator, can contribute to improving filtering anomaly. Thus, this invention implements a sophisticated feedback analysis of human inputs.

In particular, the exemplary procedure introduces an analysis process of human feedback so that the real-time measurement data can precisely be categorized or classified into normal, warning, or outlier data. The process further describes the feedback analysis of human inputs by an operator in conducting future anomaly detection. Future error value analysis employs past error values to predict future error values. Moreover, outlier prediction is not just analyzing the predicted profiles of the data but also analyzing the metadata attached to the profile, which are the error values. The analysis of the error profile enables EMS to capture the error trend where if the error rate is too large, there would be an anomaly in future behavior of the devices.

Overall, the EMS can learn from a user's inputs and reflect the human knowledge in the system when filtering outliers over anomaly data. The theoretical frameworks that have been introduced before do not accept users' inputs in real time and automatically optimize the threshold of error detection. Therefore, filtering of outliers has always been a difficult challenge with high potential of wrong detection. However, the exemplary embodiments of the present invention take full advantage of inputs from power-system experts to maximize the filtering performance that is directly applicable to the practical anomaly detection application in EMS.

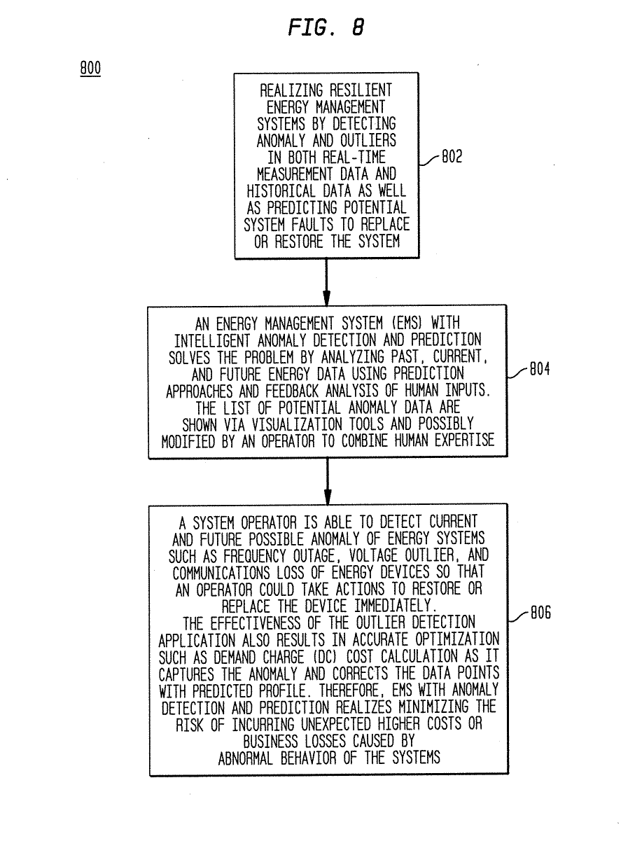

FIG. 8 is a block/flow diagram 800 illustrating optimization of usage of energy systems, in accordance with embodiments of the present invention.

At block 802, resilient energy management systems can be realized by detecting anomaly and outliers in both real-time measurement data and historical data, as well as predicting potential system faults to replace or restore the energy management system.

At block 804, the exemplary embodiments of the present invention present an EMS with intelligent anomaly detection and prediction, which analyzes past, current, and future energy data using prediction approaches and feedback analysis of human inputs. The list of potential anomaly data are shown via visualization tools and possibly modified by an operator to combine human expertise.

At block 806, a system operator can detect current and future possible anomaly of energy systems such as frequency outage, voltage outlier, and communications loss of energy devices so that an operator can take actions to restore or replace the device immediately. The effectiveness of the outlier detection application also results in accurate optimization such as DC cost calculation as it captures the anomaly and corrects the data points with the predicted profile. Therefore, EMS with anomaly detection and prediction realizes minimizing the risk of incurring unexpected higher costs or business losses resulting from abnormal behavior of the systems. Human knowledge and experience by operators often become an important asset when improving the anomaly detection. The algorithms described herein illustrate how the feedback from an operator after visualizing the detection results is employed in the filtering process of outlier data to refine the future anomaly detection process.

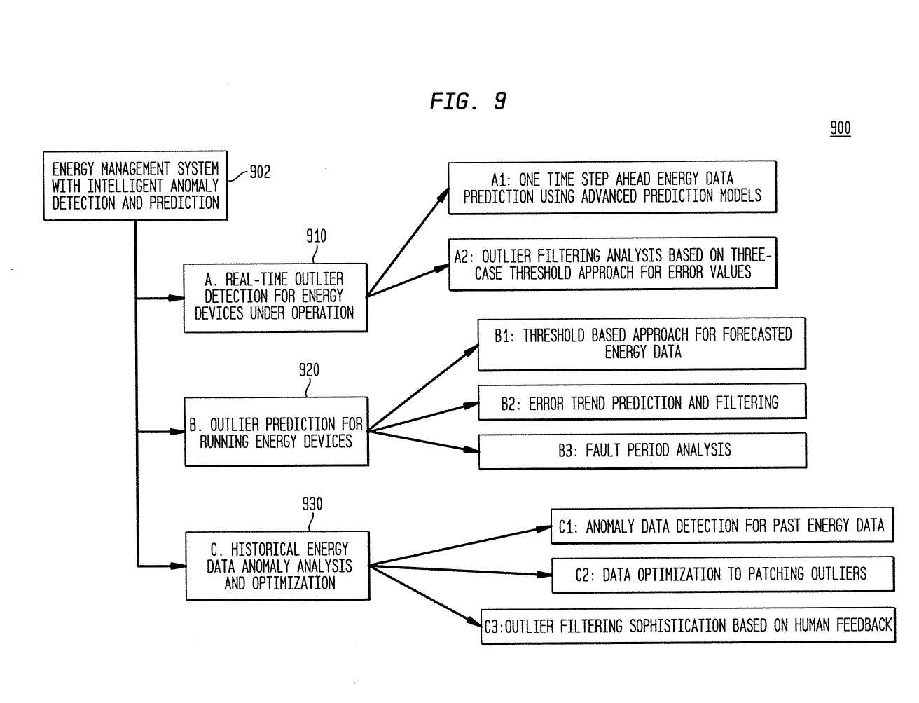

FIG. 9 is a block/flow diagram 900 illustrating execution of an energy management system with intelligent anomaly detection and prediction, in accordance with embodiments of the present invention.

The energy management system with intelligent anomaly detection and prediction 902 can be implemented by employing three modules, that is, a real-time outlier detection module 910 for energy devices under operation, an outlier prediction module 920 for running energy devices, and a historical energy data anomaly analysis and optimization module 930.

The real-time outlier detection module 910 can be implemented by one time step ahead energy data prediction using advanced prediction models and by outlier filtering analysis based on a three-case threshold approach for error values.

The outlier prediction module 920 can be implemented by a threshold-based approach for forecasted energy data, by an error trend prediction and filtering module, and by fault period analysis.

The historical energy data anomaly analysis and optimization module 930 can be implemented by anomaly data detection for past energy data, by data optimization to patching outliers, and by outlier filtering sophistication based on human feedback.

Therefore, detection of the possible outliers leads to resilient operation of the energy systems such as batteries by preventing the energy management systems from sudden interruption caused by their failures, which minimize the losses, including blackouts. Detecting and predicting potential system faults are of importance to the energy management business as stability with resiliency is among the highest priorities in sustaining the operations. In addition, use of the damaged profiles to optimize the grid or energy systems cause the miscalculation of control points such as charging and discharging profiles for batteries. For instance, because of miscalculation of the profiles, EMS will not be able to capture the load peak and misses a chance to curtail peak load when it is necessary. That causes incurring higher cost by receiving extra power from the grid, which increases the cost of demand charge for BTM customers. In addition, human knowledge and experience by operators often becomes an importance asset when improving the anomaly detection. The unique algorithms advanced herein describe how the feedback from an operator, after visualizing the detection results, can be utilized in the filtering process of outlier data to refine the future anomaly detection process.

In summary, the exemplary embodiments of the present invention employ an EMS with intelligent anomaly detection techniques that achieve real-time detection of outlier(s), prediction of future fault(s), and extraction and amendment of anomaly past data. The energy management systems have adopted advanced outlier detection theories and frameworks to optimize the use of key energy systems such as distributed energy storages with performance tracking and diagnosis mechanisms. Those advanced detection mechanisms have been integrated with the distributed energy management systems that communicate with one another to handle the current and potential outlier(s), which realizes the resilient operation of energy systems to avoid sudden interruption of operation. As one of the applications of the anomaly detection to energy management with distributed battery optimization, the framework has also been verified in the use case of DC cost reduction optimization where the comparison of the optimization results using anomaly and modified load data demonstrates the precise calculation of DC threshold, which reduces the cost incurred from the use of energy in peak-time DC periods.

Moreover, the exemplary embodiments of the present invention illustrate a visualization engine implemented on top of the EMS components that enables human interaction with experts with energy-domain knowledge such as power system operators. Through the user interface, an operator or user is able to keep track of the system's behavior and modify one or more parameters used in the anomaly detection.

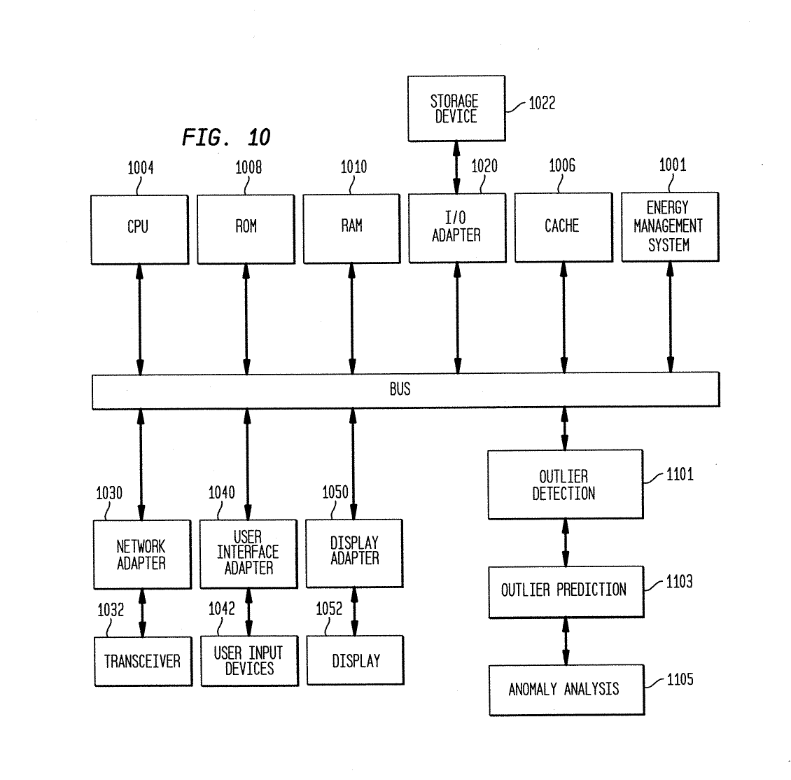

FIG. 10 is an exemplary processing system for training fast models for real-time object detection with knowledge transfer, in accordance with embodiments of the present invention.

The processing system includes at least one processor (CPU) 1004 operatively coupled to other components via a system bus 1002. A cache 1006, a Read Only Memory (ROM) 1008, a Random Access Memory (RAM) 1010, an input/output (I/O) adapter 1020, a network adapter 1030, a user interface adapter 1040, and a display adapter 1050, are operatively coupled to the system bus 1002. Additionally, an energy management system 1001 is operatively coupled to the system bus 1002. The energy management system 1001 achieves anomaly detection by employing outlier detection module 1101, outlier prediction module 1103, and anomaly analysis module 1105.

A storage device 1022 is operatively coupled to system bus 1002 by the I/O adapter 1020. The storage device 1022 can be any of a disk storage device (e.g., a magnetic or optical disk storage device), a solid state magnetic device, and so forth.

A transceiver 1032 is operatively coupled to system bus 1002 by network adapter 1030.

User input devices 1042 are operatively coupled to system bus 1002 by user interface adapter 1040. The user input devices 1042 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 1042 can be the same type of user input device or different types of user input devices. The user input devices 1042 are used to input and output information to and from the processing system.

A display device 1052 is operatively coupled to system bus 1002 by display adapter 1050.

Of course, the energy management processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the energy management processing system are readily contemplated by one of ordinary skill in the art given the teachings of the present invention provided herein.

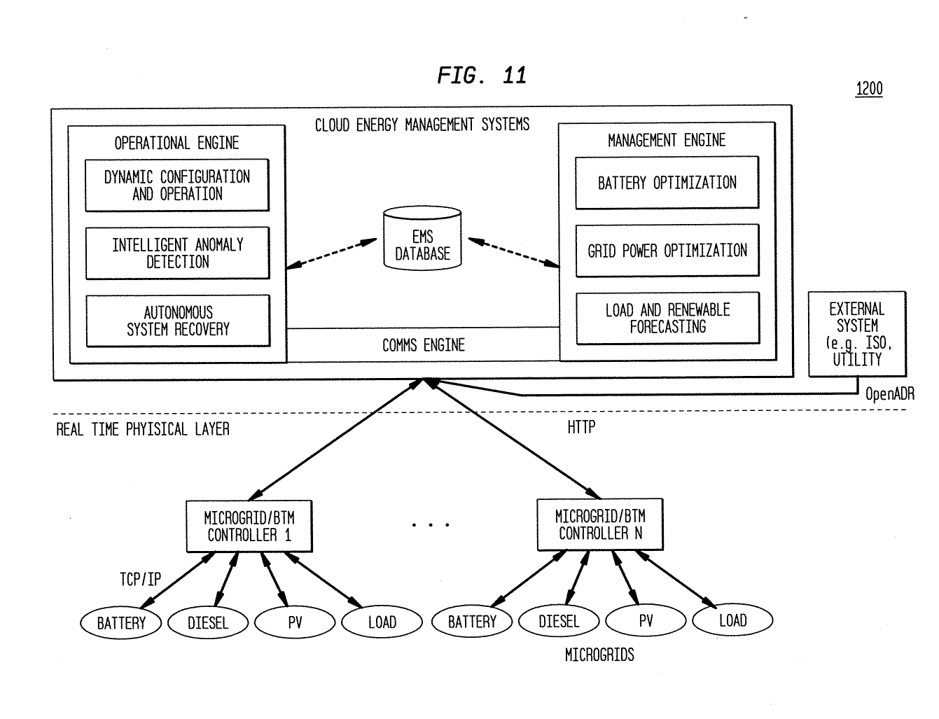

FIG. 11 is an exemplary resilient distributed architecture of an energy management system (EMS) 1200, in accordance with embodiments of the present invention.

The autonomous energy platform enables dynamic configuration and operation, fault detection, and system recovery. The EMS 1200 consists of an Operational Platform, a Management Engine, Resilience Controller(s), and an EMS Database, all of which are connected through Internet communications protocols, data connection such as Java Persistence API (JPA), or local network protocols.

The Operational Platform makes the EMS operations more resilient where the autonomous mechanisms are enabled with system upgrade, maintenance, enhancement, and failure recovery. The Management Engine aggregates distributed energy resources (DERs) to conduct economic optimization and dispatches management commands to the energy resources. The Management Engine receives the input of historical data on load and renewable profiles and conducts forecasting and generates optimum battery and grid-power profiles based on, e.g., electricity price, battery degradation, and demand charge rates. The Resilience Controller, which is described with application of real-time anomaly detection, aggregates the devices that require controls with seconds usually installed in the microgrid/BTM premises. Moreover, intelligent anomaly detection functions have been implemented in the Operational Platform and the Resilience Controller, and data that has been analyzed is employed by the Management Engine. Also, a visualization engine can be implemented on top of the EMS components that enables human interaction with experts with energy-domain knowledge, such as power system operators. Through the user interface, an operator is able to keep track of the systems behavior and modify parameters used in the anomaly detection.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for detecting and predicting anomalies in an energy management system, the method comprising:
detecting, in real-time, a first set of outliers for a plurality of energy devices under operation;
predicting a second set of outliers for running the plurality of energy devices;
analyzing historical energy data of the plurality of energy devices to extract a third set of outliers;
receiving feedback, in real-time, from a user regarding each of the first, second, and third sets of outliers; and
training the energy management system with the real-time feedback received from the user to automatically optimize a threshold of error detection.

2. The method of claim 1, wherein the predicting of the second set of outliers involves analyzing future energy data and analyzing future error values.

3. The method of claim 2, wherein the future error values are predicted by employing past error values stored in the energy management system.

4. The method of claim 3, wherein an error trend is predicted by analyzing whether the future error values are within a range of an error threshold.

5. The method of claim 4, further comprising analyzing metadata attached to the second set of outliers.

6. The method of claim 1, wherein the detecting of the first set of outliers includes classifying incoming energy measurement data into normal data, warning data or outlier data, the outlier data classification capable of being adjusted by the user.

7. The method of claim 1, wherein the first set of outliers are determined based on error-filtering thresholds attached to a plurality of filtering parameters.

8. A system for detecting and predicting anomalies in an energy management system, the system comprising:
a memory; and
a processor in communication with the memory, wherein the processor runs program code to:
detect, in real-time, a first set of outliers for a plurality of energy devices under operation;
predict a second set of outliers for running the plurality of energy devices;
analyze historical energy data of the plurality of energy devices to extract a third set of outliers;
receive feedback, in real-time, from a user regarding each of the first, second, and third sets of outliers; and
train the energy management system with the real-time feedback received from the user to automatically optimize a threshold of error detection.

9. The system of claim 8, wherein the predicting of the second set of outliers involves analyzing future energy data and analyzing future error values.

10. The system of claim 9, wherein the future error values are predicted by employing past error values stored in the energy management system.

11. The system of claim 10, wherein an error trend is predicted by analyzing whether the future error values are within a range of an error threshold.

12. The system of claim 11, wherein metadata attached to the second set of outliers are analyzed.

13. The system of claim 8, wherein the detecting of the first set of outliers includes classifying incoming energy measurement data into normal data, warning data or outlier data, the outlier data classification capable of being adjusted by the user.

14. The system of claim 8, wherein the first set of outliers are determined based on error-filtering thresholds attached to a plurality of filtering parameters.

15. A non-transitory computer-readable storage medium comprising a computer-readable program for detecting and predicting anomalies in an energy management system, wherein the computer-readable program when executed on a computer causes the computer to perform the steps of:
detecting, in real-time, a first set of outliers for a plurality of energy devices under operation;
predicting a second set of outliers for running the plurality of energy devices;
analyzing historical energy data of the plurality of energy devices to extract a third set of outliers;
receiving feedback, in real-time, from a user regarding each of the first, second, and third sets of outliers; and
training the energy management system with the real-time feedback received from the user to automatically optimize a threshold of error detection.

16. The non-transitory computer-readable storage medium of claim 15, wherein the predicting of the second set of outliers involves analyzing future energy data and analyzing future error values.

17. The non-transitory computer-readable storage medium of claim 16, wherein the future error values are predicted by employing past error values stored in the energy management system.

18. The non-transitory computer-readable storage medium of claim 17, wherein an error trend is predicted by analyzing whether the future error values are within a range of an error threshold.

19. The non-transitory computer-readable storage medium of claim 15, wherein the detecting of the first set of outliers includes classifying incoming energy measurement data into normal data, warning data or outlier data, the outlier data classification capable of being adjusted by the user.

20. The non-transitory computer-readable storage medium of claim 15, wherein the first set of outliers are determined based on error-filtering thresholds attached to a plurality of filtering parameters.
